(19) United States
(12) Patent Application Publication
(10) Pub. No.: US 2019/0377412 A1
(43) Pub. Date: Dec. 12, 2019

(54) Force Rendering Haptic Glove

(71) Applicants: Mohammad Sina Parastegari, Campbell, CA (US); Milos Zefran, Oak Park, IL (US)

(72) Inventors: Mohammad Sina Parastegari, Campbell, CA (US); Milos Zefran, Oak Park, IL (US)

(21) Appl. No.: 16/378,564

(22) Filed: Apr. 9, 2019

Related U.S. Application Data
(60) Provisional application No. 62/682,880, filed on Jun. 9, 2018.

(51) Int. Cl. G06F 3/01; A63F 13/285

(52) U.S. Cl. CPC G06F 3/016; G06F 3/014; A63F 13/285

(57) ABSTRACT

A force rendering haptic glove interface is presented that has multiple magnetic actuators positioned on the glove. Each magnetic actuator includes multiple small electromagnetic coils. Multiple positioning sensors are placed on the glove. An external magnetic field generation setup is provided that consists of multiple stationary electromagnetic coils. A controller unit is placed on the glove cuff that receives the position of the sensors and controls the electrical current of electromagnetic coils in the actuators on the glove based on received force feedback data.

### RELATED U.S. APPLICATION DATA

Provisional application No. 62/682,880, filed on Jun. 9, 2018.

### FIELD OF THE INVENTION

The present invention relates to virtual reality technology and haptic devices that provide force feedback to a user, and more specifically to a glove interface that provides force feedback using magnetic actuators.

### BACKGROUND OF THE INVENTION

With the rapid progress in the virtual reality (VR) technology, handful of devices are introduced to the market that can visually render 3D virtual objects for the user. Head-mounted displays (HMDs) with a small screen in front of the eyes are used to generate realistic images that simulate the user's physical presence in a virtual environment. More sophisticated HMDs incorporate positioning systems that track the user's movements. The rendered scene on the display is then changed accordingly, so the user can look around, move around and interact with virtual features/items in the artificial world. VR has applications in engineering, medicine, video games, military, etc.

In Augmented Reality (AR), the user can interact with the physical real-world environment whose elements are “augmented” by computer-generated virtual sensory input such as video and graphics. This augmentation is achieved using various rendering devices such as optical projection systems, monitors and hand-held devices. Optical head-mounted displays (OHMDs) are wearable devices that have the capability of reflecting projected images as well as allowing the user to see through the display. Notable commercially available OHMDs include MicroOptical MV-1, Lumus DK-40 and Microsoft HoloLens.

Haptic devices are actuated human-machine interfaces that are used to simulate physical interaction with virtual environments. Haptic devices can be in the form of robotic handles, grippers, joysticks, gloves or even a mouse. The most common type of haptic devices are the robotic handles that provide grounded force feedback for the user. Examples of robotic haptic devices are 3D Systems Geomagic Touch (formerly Omni) and Touch X (formerly PHANToM) devices. Robotic haptic devices lack dexterity (only the handle can provide force feedback) and they limit the user's freedom of motion due to the limited workspace.

Haptic gloves are a complex category of haptic interfaces that are used to track the user's hand motions and provide haptic feedback. A haptic glove needs to provide sustained forces to multiple fingers, it should be light and it should preserve the user's natural arm freedom of motion as much as possible. Notable haptic gloves available in the market include CyberGlove (no force feedback), CyberTouch (only tactile feedback) and CyberGrasp (only between-fingers grasp force feedback) from CyberGlove Systems, University of Siena's GESTO glove (only tactile feedback) and the Rutgers Master II (only between-fingers grasp force feedback). There is no product available that can provide un-grounded force feedback for the user.

Another example of a haptic glove interface is disclosed in U.S Patent No. 2016/0342207 A1 (hereinafter, referred to as '207 patent). The glove interface disclosed in '207 patent has multiple magnetic objects placed on one side of the glove and multiple electromagnets placed on the other side. A controller device activates the electromagnets to attract one or more of the magnetic objects and simulate tactile feedback to the user. Similar to other gloves mentioned above, the one disclosed in '207 patent can only provide tactile feedback (pressure) but no force feedback.

The force rendering haptic glove presented in this invention is a wearable haptic device that provides un-grounded force feedback, giving the user the ability to touch the 3D objects and physically interact with a virtual scene that is visually rendered on a monitor or a head-mounted display. The present invention further expands the Virtual Reality (VR) technology by adding the capability of haptically rendering virtual 3D objects for the user.

### SUMMARY OF THE INVENTION

The goal of this invention is to provide un-grounded force feedback through a haptic glove, adding the sense of touch to the VR and AR experience. While the user can see 3D objects on a display, he/she will be able to reach out to the objects in the virtual world and physically touch, grasp and move the virtual objects. The invented force rendering haptic glove incorporates positioning sensors to track the user's hand position. Virtual objects are then haptically rendered by applying force to the different spots on the glove through small magnetic force rendering actuators installed on the glove. Furthermore, the invented force rendering haptic glove is dexterous (applies force to multiple fingers).

The fundamental element of the invention is Magnetic Force Rendering Actuator (MFRA). In one embodiment, an MFRA has three small electromagnetic coils perpendicular to each other and intersecting at the middle. The idea is to place the MFRA inside a non-uniform external magnetic field and apply electrical current to the coils. The interaction of the external magnetic field and the small magnetic fields generated by each coil will generate a magnetic force that acts on the MFRA. By controlling the electrical current in each coil, we can control the magnetic force in three directions (x, y, z). In addition to that, by measuring the electromotive force (EMF) voltage of each coil the position and the orientation of each MFRA can be determined with respect to the external non-uniform magnetic field. Further positioning sensors are placed near the MFRAs for fine position and orientation measurement.

The force rendering haptic glove is a fabric wearable device with multiple MFRAs installed on it. All of the MFRAs are connected to a controller unit installed on the glove. The controller unit is a programmable device that connects to a PC and sends the position and orientation of each sensor to the PC. A haptic rendering software that is running on the PC computes the magnitude and the direction of the force that each actuator has to apply based on the position of the hand relative to virtual objects in a virtual reality scene. The force feedback data is sent back to the controller unit. The controller unit then computes and applies the required electrical current to each of the three coils in each actuator based on the position of the actuator relative to the external non-uniform magnetic field. Hence, virtual objects are haptically rendered for the user by controlling the force on specific spots of the glove that the MFRAs are attached to.

### BRIEF DESCRIPTION OF THE DRAWINGS

For a more complete understanding of the invention, reference is made to the following description and accompanying drawings, in which:

FIG. 1 Illustrates the force rendering haptic glove with the controller unit, the MFRAs and the positioning sensors, in accordance with an embodiment of the invention;

FIG. 2 Illustrates a Magnetic Force Rendering Actuator (MFRA) with three perpendicular electromagnetic coils, in accordance with an embodiment of the invention;

FIG. 3 Illustrates the external magnetic field generation setup with large electromagnetic coils installed on three different axes (x, y, z), in accordance with an embodiment of the invention;

FIG. 4 Shows a user in a virtual reality setup wearing the force rendering haptic glove and a head-mounted display. Also, partially illustrated in this figure is the external magnetic field generation setup, in accordance with the embodiment of FIG. 3; and

FIG. 5 Illustrates a block diagram of the components of the force rendering haptic glove. In accordance with an embodiment of the invention, a personal computer sends force feedback data to the controller unit and the video signals to a head-mounted display.

### DETAILED DESCRIPTION OF THE PREFERRED EMBODIMENTS

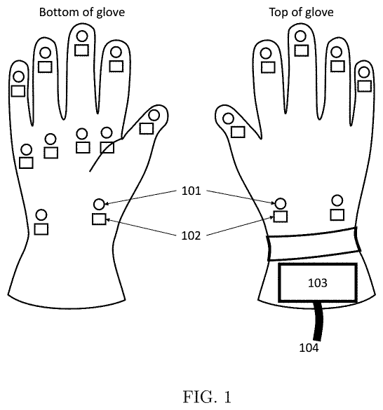

: FIG. 1 shows one embodiment of the force rendering haptic glove. In this embodiment, there are eighteen magnetic force rendering actuators (MFRA) 101 installed on the glove (five on the finger tips, six on the palm and seven on the back side). All of the actuators are connected to a unit controller 103 that measures the EMF voltage and controls the electrical current in each coil of each actuator. In one embodiment, there is one positioning sensor 102 near each MFRA. All the positioning sensors are also connected to the controller unit. In one embodiment, the controller unit 103 is connected to a PC through a FireWire connection 104.

In FIG. 1 the controller unit 103 is installed on the glove's cuff. This unit receives the position and orientation of each positioning sensor 102 and sends the data to a PC. A 3D haptic rendering software that is running on the PC estimates the configuration of the user's hand and the position of each actuator. The required force for each actuator is determined based on its position relative to virtual objects in a virtual reality scene and the commands are sent back to the controller unit. The controller unit then generates proper electrical current for each actuator 101.

In other embodiments of the force rendering haptic glove, any number of MFRAs might be installed on the glove in any configuration. Zero or more positioning sensors might be installed on the glove in any configuration. The controller unit may be connected to a PC or any other processing device such as a tablet, smart phone or an embedded processor that generates force feedback data. In other embodiments, the controller unit may work as a stand-alone device that does all the required analysis and generates the electrical current for each actuator.

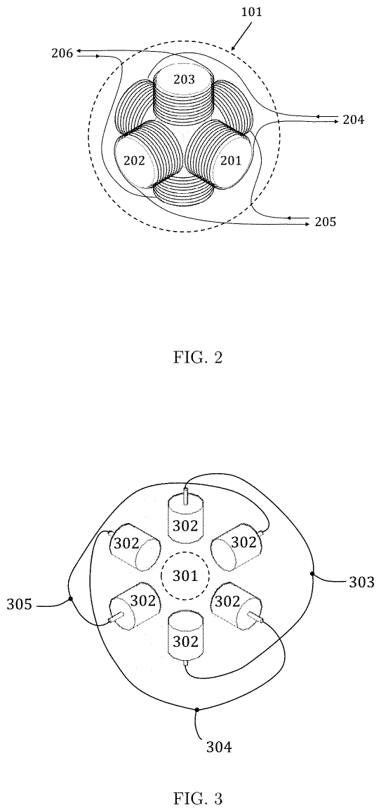

: FIG. 2 shows one embodiment of magnetic force rendering actuator (MFRA) 101. In this embodiment, the MFRA consists of three small perpendicular electromagnetic coils 201 202 203. In this embodiment, each electromagnet is a solenoid of less than 2 cm height, less than 1 cm diameter and has between 100 to 10000 turns of winding. For each solenoid, the electromotive force (EMF) voltage is measured and the electrical current (namely iₓ 204, i_{y} 205 and i_{z} 206) is controlled by the controller unit 103 of FIG. 1.

: There will be magnetic force acting on a solenoid when an electrical current is applied and the solenoid is placed in an external non-uniform magnetic field. The force magnitude can be controlled by changing the electrical current of the solenoid. By controlling the force acting on the three solenoids of each MFRA, the total acting force on the MFRA can be controlled in three dimensions (x, y, z).

: In other embodiments, the MFRA may consist any number of electromagnetic coils in any configuration. In other embodiments, each electromagnetic coil can be a solenoid of any dimension with any number of winding turns.

FIG. 3 shows one embodiment of external magnetic field generation setup. In this embodiment, the setup consists of six stationary electromagnetic coils 302. In this embodiment, the electromagnets are grouped in three pairs and each pair is installed on one of the Cartesian axes (x, y and z). Electromagnets are powered to generate three non-uniform magnetic fields in three directions. The generated external magnetic field interacts with the MFRAs installed on the glove and generates magnetic force acting on the MFRAs. The magnitude of the external magnetic field in each direction can be controlled by changing the electrical current of each pair of electromagnets (namely Iₓ 303, I_{y} 304 and I_{z} 305).

In one embodiment, each stationary electromagnetic coils is a solenoid with 10 cm or larger height and a diameter of 10 cm or larger, with more than 1000 winding turns. In one embodiment, the electromagnets are placed at a distance of about 1 m from each other, making a workspace of about 60 cm×60 cm×60 cm or larger 301. The force rendering haptic glove of FIG. 1 needs to be inside this workspace so it can generate force feedback.

In other embodiments, any number of stationary electromagnetic coils of any dimension can be installed in any configuration to generate non-uniform magnetic field. The force rendering haptic glove of FIG. 1 needs to be inside the space between the electromagnets so it can generate force feedback.

The controller unit 103 of FIG. 1 has all the information about the dimension and exact location of each stationary electromagnetic coil 302. Using a finite solenoid model for each coil, the controller unit estimates the magnitude and the direction of the external magnetic field at the current location of each MFRA 101 of FIG. 1. The controller unit then computes and applies the required electrical current to each MFRA to generate the required force at that specific spot of the glove.

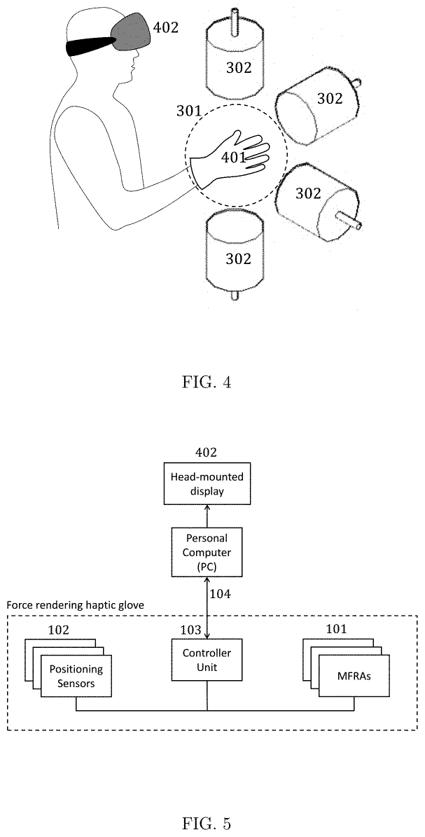

FIG. 4 shows one embodiment of virtual reality setup in which the force rendering haptic glove is used. A user has worn the force rendering haptic glove 401 on his/her right hand. In this embodiment, the user is also wearing a head-mounted display 402. The external magnetic force generation setup is partially illustrated in FIG. 4 by showing some of the stationary electromagnetic coils 302. The operable workspace for the glove is within the the space between the stationary electromagnetic coils 301.

In one embodiment, virtual 3D objects are displayed on the head-mounted display. At the same time, the same virtual objects are haptically rendered through the force rendering haptic glove. The user would be able to physically touch the virtual objects he/she is seeing on the head-mounted display using the force rendering haptic glove.

In other embodiments, multiple users might be involved interacting with each other. Each user may wear one or two force rendering haptic gloves. In other embodiments, a head-mounted display can be replaced by other types of displays such as a television, LCD monitor or any other display in accordance with the embodiments of the invention.

FIG. 5 illustrates one embodiment of a block diagram of the force rendering haptic glove components. The controller unit 103 collects position and orientation information from the positioning sensors 102 besides the EMF voltages from the MFRAs 101 and sends the information to the PC. In one embodiment, there is a FireWire connection 104 between the controller unit and the PC. A 3D haptic rendering software running on the PC calculates the force feedback required and sends the data back to the controller unit. At the same time, the same software running on the PC sends video content to the head-mounted display 402.

The controller unit 103 is configured to have all the information about the dimension and exact location of each stationary electromagnetic coil in the external magnetic field generation setup of FIG. 3. Using a finite solenoid model, the controller unit then computes the magnitude and the direction of the external magnetic field at the location of each MFRA 101. The required electrical current for each MFRA is then computed based on the required force for that MFRA and the computed external magnetic field.

In other embodiments, the personal computer can be replaced by other processing devices such as a tablet, smart phone, an embedded processor or any other processing device that is able to generate 3D video content and force feeback data. In other embodiments, the personal computer might be omitted from the components. In such embodiments, a haptic rendering software will be running on the controller unit 103 itself. In such embodiments, processing power of the controller unit 103 needs to be improved so it can generate 3D video and haptic content. In other embodiments, the FireWire connection 104 between the personal computer and the controller unit might be replaced with any other wired or wireless communication protocol, including but not limited to serial connection, USB connection, Bluetooth or WiFi. In other embodiments, the head-mounted display can be replaced by other types of displays such as a television, LCD monitor or any other type of display in accordance with the embodiments of the invention.

What is claimed:

1. A force rendering haptic glove interface comprising:
multiple magnetic force rendering actuators placed on the glove,
multiple position sensors placed on the glove,
a controller unit placed on the glove that generates electrical current for the magnetic force rendering actuators based on received force feedback data.

2. Magnetic force rendering actuators of claim 1 comprising:
multiple electromagnetic coils,
the electrical current of electromagnetic coils are controlled by the controller unit of claim 1,
the EMF voltage of electromagnetic coils are measured by the controller unit of claim 1.

3. An external magnetic field generation setup comprising:
multiple stationary electromagnetic coils, installed in different directions,
generating non-uniform magnetic field between the coils (workspace).

4. A system comprising:
the external magnetic field generation setup of claim 3,
the force rendering haptic glove interface of claim 1 operating in the workspace between the stationary electromagnetic coils of claim 3.

5. The system of claim 4,
wherein the position and orientation of each position sensor of claim 1 is received by the controller unit of claim 1,
the data from the position sensors is sent to a 3D haptic rendering software running on a processing device,
the 3D haptic rendering software computes the configuration of the glove and estimates the position of each magnetic force rendering actuator of claim 1,
the 3D haptic rendering software computes required force feedback for each actuator of claim 1 based on the position of the actuator relative to virtual objects in a virtual scene,
the force feedback data is sent back to the controller unit of claim 1,
the controller unit of claim 1 is configured to have all the information about the dimension and the exact location of each stationary electromagnetic coil of claim 3,
The controller unit of claim 1 computes and applies the required electrical current to each actuator of claim 1 using the method of claim 6.

6. A method, comprising:
using a finite solenoid mathematical model for each stationary electromagnetic coil of claim 3,
computing the magnitude and direction of generated external magnetic field for the field generation setup of claim 3 at different locations in the workspace defined in claim 3,
computing the required electrical current for each actuator of claim 1 based on the force feedback data and the position of the actuator relative to the external magnetic field.
